(19) United States
(12) Patent Application Publication
(10) Pub. No.: US 2008/0169174 A1
(43) Pub. Date: Jul. 17, 2008

(54) Safety knob switch of shredder

(75) Inventor: Simon Huang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/878,485

(22) Filed: Jul. 25, 2007

(30) Foreign Application Priority Data
Jan. 11, 2007 (CN) 200720001236.2

(51) Int. Cl. H01H 3/20

(52) U.S. Cl. 200/43.16

(57) ABSTRACT

This specification discloses a shredder having a safety knob switch, which is a knob control lock mechanism protruding from its housing. The lock mechanism restricts the switching of the switch. When the switch is in the off position, it is locked and prevented from moving arbitrarily. The lock state is released by imposing a torque on the knob, turning the knob to the auto or rev position. This prevents children from playing with the shredder switch and damaging the machine or getting hurt.

### BACKGROUND OF THE INVENTION

1. Field of Invention

The invention relates to a shredder and, in particular, to a safety knob switch that prevents children from playing with the machine and damaging it or getting hurt.

2. Related Art

The action principle of most well-known shredders for shredding paper is to utilize several cutting blades along with spacers installed on two parallel rotary shafts that are driven by a motor and a gear box to rotate in opposite directions. A shearing force thus imposes on passing paper and cuts it into thin stripes. According to the mechanical cutting modes, shredders are divided into two types: stripe-cut shredders and cross-cut shredders. In the former case, the cutting blades are disposed regularly on the rotary shafts and cut the paper along the longitudinal direction into long stripes. Each blade on the latter has several hook-shaped cutting edges. The blades are disposed in a spiral way on the rotary shafts. In this case, the paper is not only cut along the longitudinal direction into stripes, but also cut in the transverse direction into chips.

The operation panel of conventional shredders has an on/off switch. The user can manually operate the switch to switch the shredder among the auto, off, and rev functions. After the usual shredders are installed, the switch is usually set to auto for use. Since the on/off switch can be arbitrarily switched without any safety lock, it is potentially dangerous for children. If a child plays with the switch and changes it to the rev mode, the motor and cutting blades of the shredder will reverse their rotating direction, producing noise all of a sudden. The sudden noise may frighten the child, so that he/she leaves the scene without knowing what to do. The shredder in the rev mode then continues the operation before it is switched to off or auto, and can possibly be damaged due to overload. What is even worse is that the sudden noise does not frighten the child, but instead intrigues him/her to look for the sound source. In that case, the cutting blades in operation may hurt the child in a more dangerous way.

### SUMMARY OF THE INVENTION

An objective of the invention is to provide a safety knob switch for the shredder to prevent children from arbitrarily playing the shredder switch. When the shredder is in the auto mode, arbitrarily pushing the switch may shift it to the off position and lock it. A torque has to be imposed in order to release the lock state of the switch. Children are thus effectively prevented from playing with the switch, damaging the machine, or even getting hurt.

To achieve the above objective, the disclosed safety knob switch for the shredder is a knob control lock mechanism protruding from the shredder housing. The lock mechanism restricts the switching of the switch. When the switch is in the off position, the switch is locked and cannot move arbitrarily. A torque has to be imposed on the knob in order to release the lock state, before the knob and the switch can be pushed to the auto or rev position. This mechanism prevents children from arbitrarily playing with the shredder switch, damaging the machine, or getting hurt.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the invention; and

FIG. 2 is a planar view of the assembled product.

### DETAILED DESCRIPTION OF THE INVENTION

The present invention will be apparent from the following detailed description, which proceeds with reference to the accompanying drawings, wherein the same references relate to the same elements.

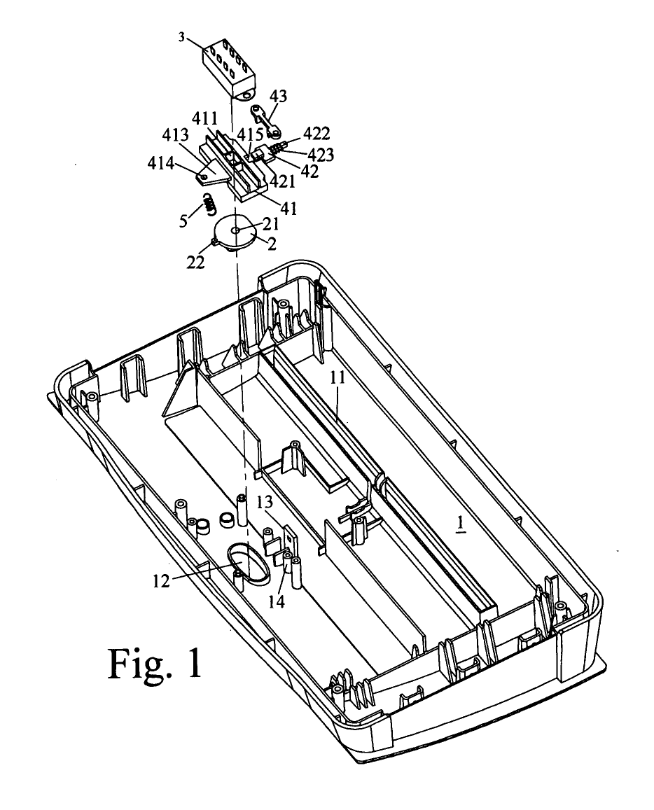

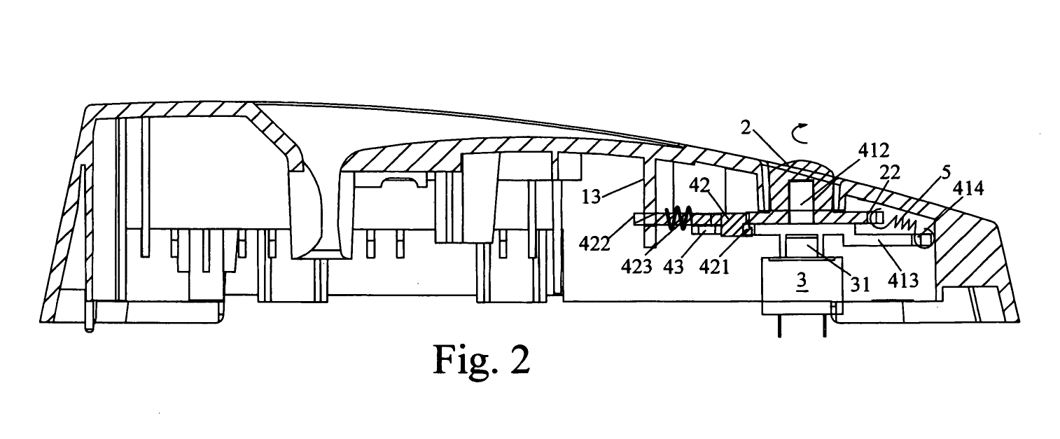

FIG. 1 is a three-dimensional exploded view of the invention. FIG. 2 is a planar view of the invention after assembly. As shown in the drawings, the shredder housing 1 has an opening 11 for inserting paper and a switch hole 12 for positioning the knob 2 and protruding from the shredder housing 1. This is convenient for the user to make a switch with fingers.

A lock mechanism is provided between the knob 2 and the switch 3 to restrict the switching of the switch 3. The lock mechanism comprises a body 41 and a position limiting block 42. A hole 411 is formed at the center of the bottom of the body 41 for a switch button 31 to be embedded. A shaft 412 is provided at the center of the front surface of the body, inserting into a knob hole 21, so that the knob 2 can directly control the switch 3 via the body 41. A board 413 protrudes from one side of the body 41, with a hook hole 414 formed at its tip. Corresponding to the position of the hook hole 414, a hook base 22 is provided around the knob 2. Both ends of a pulling spring 5 are fixed in the hook hole 414 and the hook base 22, respectively. A positioning indent 415 is formed on the other side of the body 41 for a lock element 421 on one end of the position limiting block 42 to be embedded therein. The other end of the positioning limiting block 42 has a pin 422 mounted with a spring 423 and inserted into a fixing board 13 in the shredder housing 1. The entire position limiting block 42 is fixed by the pressing board 43 on a base 14 in the shredder housing 1.

When the switch is at the off position, the lock element 421 of the position limiting block 42 is inserted in the positioning indent 415 of the boy 41. Therefore, the switch 3 cannot be arbitrarily switched. However, when the knob 2 is under a torque indicated by the arrow, the body 41 rotating with the knob 2 pushes the lock element 421 of the position limiting block 42 away from the embedded position in the positioning indent 415. The lock state of the body 41 is thus released. In this case, one can push the knob 2 to change the switch 3 from the original off position to the auto or rev position. On the other hand, to change the switch 3 from the auto or rev position to the off position, one only needs to push the knob 2. Once the switch 3 goes back to the off position, the body 41 pushes the lock element 421 of the position limiting block 42 back to the positioning indent 415 under the restoring force of the spring 423. The rotated body 41 returns to its original position, and the pulling spring 5 pulls the knob 2 back to its initial position.

In summary, the disclosed safety knob switch for the shredder is a knob control lock mechanism protruding from the shredder housing. The lock mechanism restricts the switching of the switch. When the switch is in the off position, it is locked and prevented from moving arbitrarily. The lock state is released by imposing a torque on the knob, turning the knob to the auto or rev position. This prevents children from playing with the shredder switch and damaging the machine or getting hurt.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A safety knob switch for a shredder, which comprises:
a shredder housing, which is provided with a switch hole;
a knob, which is positioned in the switch hole and protrudes from the shredder housing for the user to make a switch using fingers;
a switch, which allows the shredder to change among auto, off, and rev modes; and
a lock mechanism, which is disposed between the knob and the switch to restrict the switching of the switch;
wherein the switch is locked and prevented from shifting when it is in the off position, and a torque has to be imposed on the knob to release the lock state and push the knob and the switch to the auto or rev position.

2. The safety knob switch for a shredder of claim 1 with the lock mechanism further including a body and a position limiting block, wherein
a hole is formed at the center of the bottom surface of the body for embedding the switch button;
a shaft is provided at the center of the front surface of the body for inserting into a bottom hole of the knob and directly controlling the switch;
a board extends from one side of the body outward, with a hook hole formed at the tip of the board;
a hook base is formed around the knob corresponding to the hook hole;
a pulling spring is fixed between the hook hole and the hook base with its two ends;
the other side of the body is formed with a positioning indent for a lock element of the positioning limiting block to be embedded therein;
the other end of the position limiting block has a pin mounted with a spring and inserted into a fixing board in the shredder housing; and
the position limiting block is fixed by the pressing board on a base in the shredder housing.

3. The safety knob switch for a shredder of claim 1, wherein
when the switch is in the off position, the lock element of the position limiting block is inserted in the positioning indent of the body, preventing the switch from arbitrarily switching; and
when the knob is under a torque, the body rotating with the knob pushes the lock element of the position limiting block away from its original embedded position in the positioning indent, releasing the lock state of the body and allowing the change of the switch from the original off position to the auto or rev position by pushing the knob.
